(19) United States
(12) Patent Application Publication
(10) Pub. No.: US 2004/0036580 A1
(43) Pub. Date: Feb. 26, 2004

(54) Honkette courtesy horn

(76) Inventor: Gary Michelson, Yorkville, IL (US)

Correspondence Address: GARY MICHELSON, 405 E. PARK ST., YORKVILLE, IL, 60560, US

(21) Appl. No.: 10/225,642

(22) Filed: Aug. 23, 2002

(51) Int. Cl. G08B 3/00

(52) U.S. Cl. 340/388.1; 340/425.5

(57) ABSTRACT

This variable decibel level horn seeks to solve the particular problem caused by and associated with the use of the current vehicle horn. The unintentional outcome is that the person being honked at becomes irate and aggressive toward the person honking at them. This device solves this problem by producing a lower decibel sound that is less irritating to the driver being honked at. Sometimes in traffic it becomes necessary to honk at a motorist or pedestrian who has become pre-occupied. At this time to get this or her attention it becomes necessary to sound the vehicle's horn. This irritates the driver sometimes to the point of the so-called “road-rage” condition. With this device, the sounding of a lower decibel horn or even a completely different tone or sound has a more calming effect on the individual. This invention is designed to get the other person's attention without the overkill of such a loud horn.

### BACKGROUND OF INVENTION

This patent applies to the automotive industry. This invention provides a needed product for all automobile and truck drivers. The term “automotive horn” has its common meaning that includes a device installed in automotive vehicles for causing a sound for warning pedestrians or other cars or trucks. The automotive horn is also used as a “reminder” to other automobiles or trucks to proceed when a traffic light has turned green or in other instances where the person being honked at is not fully observing the current situation. The horn is also used to warn of potential dangerous conditions.

This invention has sought to provide a lower decibel honk as such described as the “courtesy honk”. This lower decibel honk will not provoke such a negative and harsh response from the person being honked at. By having a lower sounding honk, the person being honked at will not feel so outraged at the person doing the honking. This in turn will lead to safer roads and less life threatening reactions by the public. Since people will be less offended by a lower volume honk, these same people will react in a much friendlier means than previously by honking at them with a higher decibel horn.

This invention is not to replace the current horn in cars of trucks. This device is to be in addition to the current horn. The current horn can and should be used in emergency situations. This invention will be used as a courtesy sounding so as not to offend people. This non-offensive horn will greatly aid in the reduction of the so “road-rage” incidents. This horn is completely controlled by the driver of the automobile or truck. This is a significant difference to U.S. Pat. No. 6,271,746. In U.S. Pat. No. 6,271,746, the automobile actually determines the level and duration of the sound.

U.S. Pat. No. 6,271,746 deals with abuse of the horn. This invention lets the driver control both this horn at a lower decibel level and the current horn at the higher decibel level. This is a substantial difference. In this invention, the driver controls when he wants to use this lower decibel horn or the current higher decibel horn.

I claim in this invention that this invention produces a lower decibel sound. This lower decibel sound does not invoke anger in the person being honked at. This less provoking horn helps to reduce the road safety danger called “road-rage”.

### BRIEF SUMMARY OF INVENTION

This invention will consist of a button on the dashboard wired to a small separate horn in close proximity to the existing automotive horn., The button when pushed will activate the horn. This horn as stated will be a lower decibel horn.

The other way of activating this horn will be through a switching device such that gives a lower electrical current to the horn. This lower electrical current to the horn will thus result in a lower decibel honk. This can be thought in much the same as the interior light switch currently used in automobiles. As one turns the switch higher, the interior lights become brighter at a more intense level. This would be the same type of switch that could be controlled by the driver of the automobile or truck. This switch would raise or lower the amount of electrical current from the switch to the horn. This raising of the current would result in a louder honk. The lowering of the current would result in a lower decibel honk.

This lower decibel sound will be less threatening to the person being honked at. The person being honked will react with less rage than under the current high decibel sound of a vehicle's horn. This invention seeks to help lower the instance of “road rage” incidents.

### DETAILED DESCRIPTION OF INVENTION

This invention consists of a horn and an activation device such as a switch or button. The horn can be either in addition to the existing vehicle horn or use the existing horn in an automobile or truck. The activation device can be a button or switch or any other activation device.

Once the switch is pushed or activation device activated, the horn swill sound. This horn will sound at a much lower decibel level than the current horn. This lower decibel level is achieved through the sending of a smaller electrical charge to the horn than is currently sent in the existing vehicle horn.

The activation switch can be variable in the amount of current sent to the horn. This would allow the driver to adjust the volume level of the horn. This activation device can be wired to an additional horn on the vehicle or the activation device can be wired to the existing horn on the vehicle.

What I claim is:

1. That invention has a separate button that is used to sound a lower decibel horn than the horn currently installed in automobiles or trucks. This lower decibel horn can be a completely separate horn or can use the existing horn. The amount of current sent to the horn would determine the sound level of the horn.

2. The amount of current sent to the horn would be controlled by the driver of the vehicle. This control would be by the means of a dial switch that could be set to a lower or higher level of current that would be sent to the horn. The driver would set the level and then push a button or other device to sound the horn. Thus as one sent higher current to the horn, the horn would sound at a higher decibel level. Also, the reverse would be true. That being the lower the level of current sent to the horn, the lower the decibel level of the horn.

3. This horn may be used with or without the feature of raising and lowering the decibel level. The horn may also be set at a pre-determined decibel level and not adjustable.

4. An automotive horn control system for use in an automotive vehicle, said system comprising of a horn and a variable switch or single level switch.
The single level switch would be set to a desirable decibel level. The variable switch would be capable of variable levels of the flow of currency to the horn. This variable level of currency would result in variable decibel levels in the horn.
